(19) United States
(12) Patent Application Publication
(10) Pub. No.: US 2010/0089332 A1
(43) Pub. Date: Apr. 15, 2010

(54) Bird bath

(76) Inventors: Gordon S. Dye, JR., Sheffield, IA (US); Theresa A. Dye, Sheffield, IA (US)

Correspondence Address: BARTZ & BARTZ, P. A., Suite 119, 6950 France Avenue South, Edina, MN, 55435, US

(21) Appl. No.: 11/807,171

(22) Filed: May 25, 2007

Related U.S. Application Data
(60) Provisional application No. 60/808,397, filed on May 26, 2006.

(51) Int. Cl. A01K 7/04; A01K 29/00

(52) U.S. Cl. 119/69.5

(57) ABSTRACT

A bird bath has an outer bowl with a reservoir for holding water and an inner bowl floating on the water in the reservoir and supplied with water from the reservoir for bird drinking and bathing.

### CROSS REFERENCE

This application claims the priority of U.S. Provisional Application Ser. No. 60/808,397 filed May 26, 2006.

### FIELD OF THE INVENTION

The invention relates to basin ornaments accommodating water for birds to drink from and bathe in, commonly called bird baths.

### BACKGROUND OF THE INVENTION

The traditional outdoor bird baths have shallow bowls with a concave basins that curve upwardly and outwardly to the outer perimeter of the bowls. The basins hold a limited amount of water with a large surface exposed to atmosphere and sunlight. The water can be rapidly depleted in hot weather due to evaporation and bird usage. Water must be frequently added to the basins to maintain a supply of water for birds. The basins are supported on upright pedestals joined to bottom bases to support the bird baths on the ground in locations to allow birders to watch and identify birds that visit the bird baths. The bird baths are constructed of concrete or resins having numerous ornamental exterior designs.

### SUMMARY OF THE INVENTION

The bird bath of the invention has a water reservoir that provides a source of water for birds to drink and bathe which is not depleted in a short period of time. The bird bath has an outer bowl having an open top chamber providing a reservoir for holding a supply of water. The outer bowl is elevated above the ground on a pedestal joined to a support base in a selected location for viewing birds. An inner bowl having a shallow basin floats on the water in the reservoir. A floatation member cooperating with the inner bowl maintains a bottom wall of the inner bowl partly submerged relative to the surface of the water in the reservoir. The bottom wall of the inner bowl has holes that allow water from the reservoir to flow into the basin to maintain water in the basin for bird drinking and bathing.

A preferred embodiment of the bird bath of the invention has a cylindrical outer bowel having an upright sidewall with a circular top wall that surrounds a chamber or reservoir for accommodating water. The bottom of the outer bowel has a hole to allow water to drain from reservoir to facilitate cleaning of the bowl and providing fresh water to the reservoir. A removable plug closes the hole to maintain water in the reservoir. A circular inner bowl floating in the water in the reservoir provides a shallow supply of water in a basin for birds to drink and bathe. Inner bowl is a floating bird bath bowl having a bottom wall with a plurality of holes to allow water to flow upwardly from the reservoir into the basin to maintain a supply of water in the basin. In one embodiment of the inner bowl the bottom wall has a center island with a top surface useable as a perch for birds. An annular rim joined to the outer peripheral edge of the bottom wall has floatation structure that maintains the inner bowl on the surface of the water in the reservoir with the bottom wall submerged relative to the surface of the water in the reservoir. The rim has upright cylindrical inner and outer sidewalls joined to a circular top wall used as a perch for birds to drink water in the basin. The space between the sidewalls is divided with radial ribs into air pockets having bottom openings facing the water in the reservoir whereby the air in the pockets maintain the inner bowl on the surface of the water in the reservoir. The inner bowl is free to rise and fall with the level of the water in the reservoir thereby maintaining a supply of water in the basin. An alternative rim has an annular floatation member of foam plastic between its upright sidewalls to maintain the inner bowl on the surface of the water in the reservoir. Inner bowl can be removed from the outer bowl to allow the inner and outer bowls to be cleaned and supplied with fresh water.

### DESCRIPTION OF THE DRAWING

FIG. 1 is a perspective view of the bird bath adapted to hold water to allow birds to drink and bathe;

FIG. 2 is a front elevational view thereof;

FIG. 3 is a side elevational view of the right side thereof;

FIG. 4 is a top plan view thereof;

FIG. 5 is a bottom plan view thereof;

FIG. 6 is an enlarged sectional view taken along line 6-6 of FIG. 4 with water in the reservoir of the outer bowl;

FIG. 7 is a perspective view of a first modification of the bird bath of FIG. 1;

FIG. 8 is a front elevational view of FIG. 7;

FIG. 9 is a side elevational view of the right side of FIG. 7;

FIG. 10 is a top plan view of FIG. 7;

FIG. 11 is a bottom plan view of FIG. 7;

FIG. 12 is an enlarged sectional view taken along line 12-12 of FIG. 10 with water in the reservoir of the outer bowl;

FIG. 13 is a perspective view of a second modification of the two bowl birth bath of FIG. 1;

FIG. 14 is a front elevational view of FIG. 13;

FIG. 15 is a side elevational view of the right side of FIG. 13;

FIG. 16 is a top plan view of FIG. 13;

FIG. 17 is a bottom plan view of FIG. 13;

FIG. 18 is an enlarged sectional view taken along the line 18-18 of FIG. 16 with water in the reservoir of the outer bowl;

FIG. 19 is a perspective view of a third modification of the bird bath of FIG. 1;

FIG. 20 is a front elevational view of FIG. 19;

FIG. 21 is a rear elevational view of FIG. 19;

FIG. 22 is a side elevational view of the right side of FIG. 19;

FIG. 23 is a top plan view of FIG. 19;

FIG. 24 is a bottom plan view of FIG. 19;

FIG. 25 is an enlarged sectional view taken along line 25-25 of FIG. 23 with water in the reservoir of the outer bowl;

FIG. 26 is a perspective view of a fourth modification of the bird bath of FIG. 1;

FIG. 27 is a top plan view of the bird bath of FIG. 26;

FIG. 28 is a perspective view of the inner bowl of the bird bath of FIG. 26;

FIG. 29 is a top plan view of FIG. 28;

FIG. 30 is a bottom plan view of FIG. 28;

FIG. 31 is a sectional view taken along line 31-31 of FIG. 29;

FIG. 32 is a perspective view of a first modification of the inner bowl of FIG. 28;

FIG. 33 is a top plan view of FIG. 32;

FIG. 34 is a bottom plan view of FIG. 32;

FIG. 35 is a sectional view taken along the line 35-35 of FIG. 33;

FIG. 36 is a perspective view of a second modification of the inner bowl of FIG. 28;

FIG. 37 is a top plan view of FIG. 36;

FIG. 38 is a bottom plan view of FIG. 36;

FIG. 39 is a sectional view taken along the line 35-39 of FIG. 37;

FIG. 40 is a third modification of the inner bowl of FIG. 28;

FIG. 41 is a top plan view of FIG. 40;

FIG. 42 is a bottom plan view of FIG. 40; and

FIG. 43 is a sectional view taken along the line 43-43 of FIG. 41.

### DESCRIPTION OF THE INVENTION

The bird bath is illustrated as five embodiments indicated generally as 10, 100, 200, 300 and 400. Each embodiment has a first outer bowl having a reservoir for accommodating a large amount of water and a second inner bowl located within the reservoir that holds water and floats on the water in the reservoir. Birds and small animals can perch on either the first or second bowls and drink and bathe in the water in the second bowl. The bird bath has water volume capacity and water depth that is functional for most species of birds. The shapes of the inner and outer bowls are shown as cylindrical, elliptical or oval, square and triangular. The bowls can have other shapes including but not limited to rectangular, hexagonal, pentagonal, pentadecagonal, and octagonal.

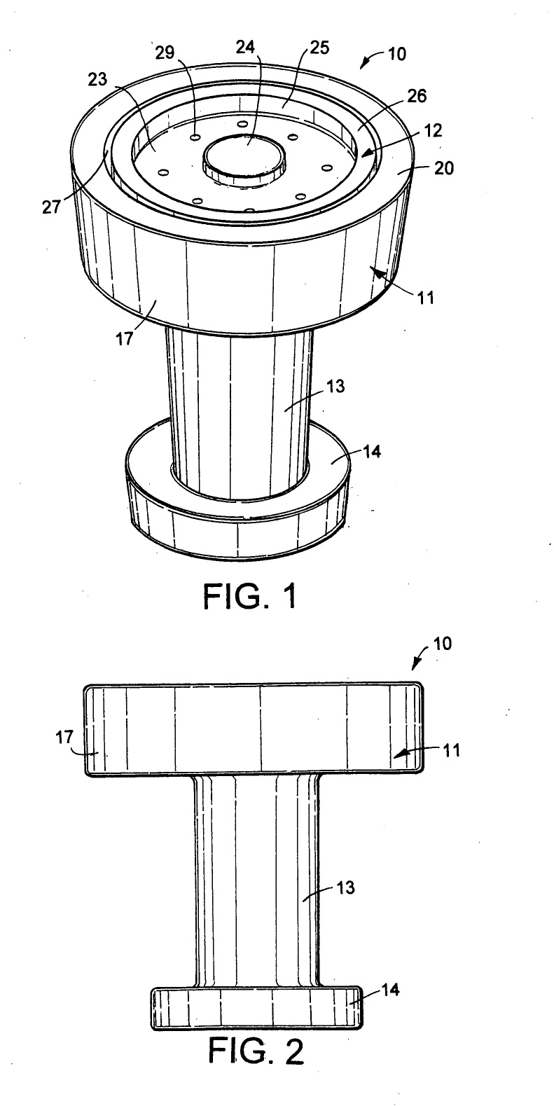

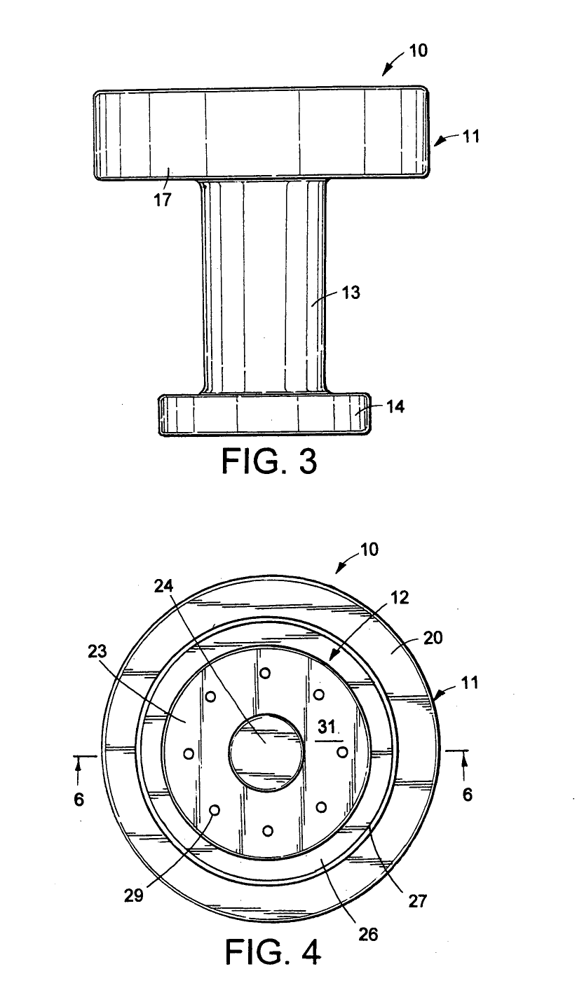

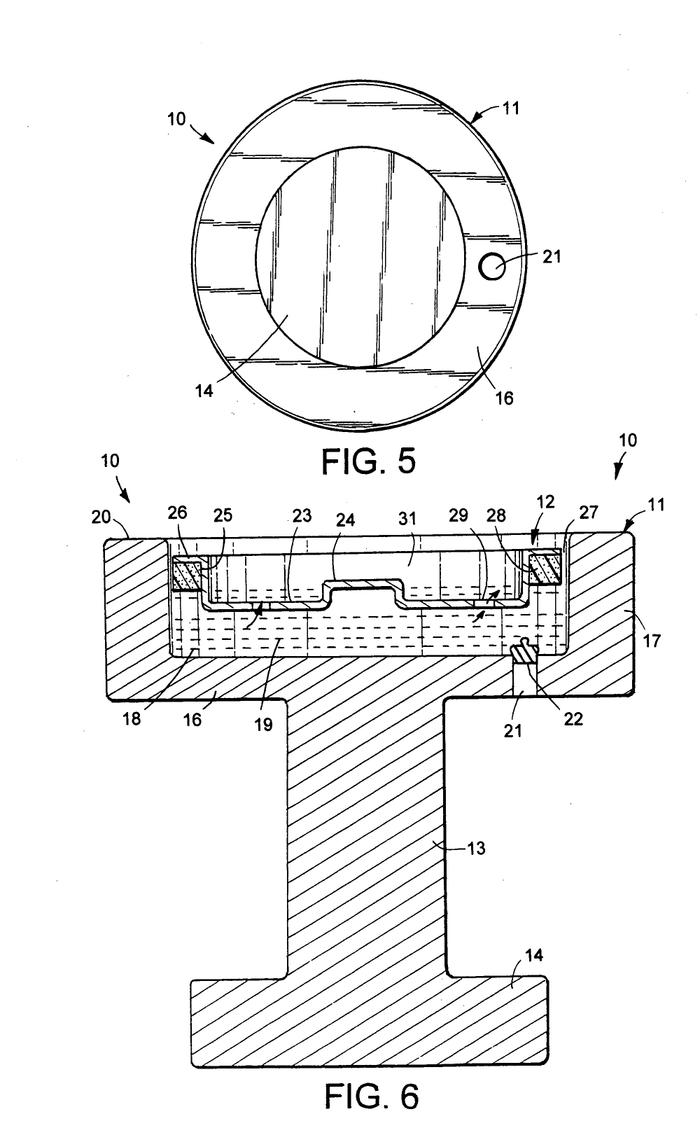

As shown in FIGS. 1 to 6, bird bath 10 has a cylindrical first outer bowl 11 surrounding a cylindrical second inner bowl 12. Bowl 11 is mounted on an upright pedestal or column 13 joined to a base or ground support member 14. The upper portion of pedestal 13 is joined to bottom wall 16 of bowl 11. Bowls 11 and 12, pedestal 13 and base 14 have cylindrical shapes to provide bird bath 10 with a coordinated cylindrical appearance. The bottom wall 16 of bowl 11 can be secured to or rest on pedestal 13. Pedestal 13 and base 14 are shown as solid members. A passage or hole can extend upwardly through pedestal 13 and base 14 to reduce the amount of material and weight of pedestal 13 and base 14. Bowl 11, pedestal 13 and base 14 are made of rigid materials including but not limited to concrete, ceramics, resins, plastics, clays, metals and wood. Bowl 11 has an upright sidewall 17 joined to the outer portion of a bottom wall 16 and a reservoir or basin 18 surrounded by sidewall 17. As shown in FIG. 6, reservoir 18 holds water which can be drained through a drain hole 21 in bottom wall 16. A rubber plug or stopper 22 extends into the upper end of hole 21 to retain water 19 in reservoir 18. Sidewall 17 has an internal height of 5 to 13 cm or 2 to 5 inches whereby reservoir 18 accommodates about 2 to 5 gallons of water. The volume of water stored in reservoir 18 is limited because birds drink, bathe and defecate in inner bowl 12. The water should be changed on a regular basis to maintain water cleanliness. Sidewall 17 has an annular top surface or ledge 20 located around and above inner bowl 12. Birds, such as blue jays, robins, sparrows and orioles, perch on ledge 20 and drink water in inner bowl 12.

Inner bowl 12 is a generally flat pan-shaped member having a flat circular bottom wall 23 including an upright circular island or perch pad 24. A circular upright sidewall 25 joined to the outer peripheral edge of bottom wall 23 surrounds a chamber or basin 31 for holding a shallow amount of water. As shown in FIGS. 4 and 6, bottom wall 23 has a plurality of passages or holes 29 that allow water to flow upwardly as shown by arrows from reservoir 18 of bowl 11 into basin 31 of bowl 12. A circular lip or flange 26 is joined to the top edge of sidewall 25. As shown in FIGS. 4 and 6, the outer circular edge of flange 26 is concentric with the inner wall of sidewall 17 and spaced inwardly therefrom with an annular space 27 whereby inner bowl 12 is free to rotate and float on the water in reservoir 18 of bowl 11. Flange 26 can be provided with a textured top surface to provide a gripping perch for birds. The bottom wall 23, sidewall 25 and flange 26 is a one-piece rigid plastic member. Other materials can be used for inner bowl 12. A floatation member 28 surrounding sidewall 25 below flange 26 floats bowl 12 partly submerged in water 19 in reservoir 18. Floatation member 28 is a circular ring of foam plastic that floats on water 19 adjacent the inside wall of sidewall 17. Floatation member 28 is spaced inwardly from the inside wall of sidewall 17 to allow bowl 12 to rise and fall with the level of the water in reservoir 18 of bowl 11. Floatation member 28 can be an air tight tubular ring attached to bowl 12. Additional lighter than water structures can be used to float bowl 12 on water 19 in reservoir 18.

In use, fresh water is placed in chamber 18 of bowl 11 on a regular basis. For example, water in reservoir 18 can be drained by removing plug 22 to allow bowl 11 to be cleaned and replace with fresh water on a daily basis. Inner bowl 12 is placed in reservoir 18 on top of water 19 therein. The water in reservoir 18 flows through holes 29 in bottom wall 23 to self fill chamber 31 of bowl 12 with an amount of shallow water having a depth of 0.5 to 1 cm or ¼ to ⅜ inch. Floatation member 28 maintains bowl 12 bottom wall 23 submerged adjacent the surface of water 19 in reservoir 18 and keeps a supply of water in basin 31. Birds can perch on flange 26 and island 24 to drink water from basin 31. In the event that a large animal, such as a squirrel or cat, gets into the bird bath, their body weight causes inner bowl 12 to sink into water 19 which discourages these animals from using the bird bath. When the animals leave the bird bath inner bowl 12 will rise and excess water drains back into reservoir 18.

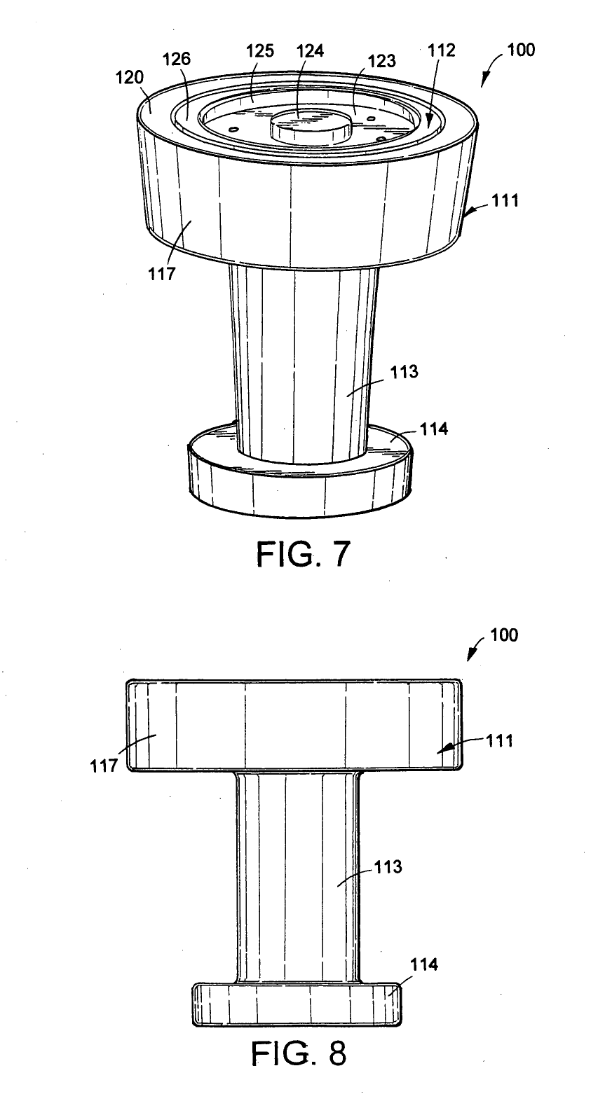

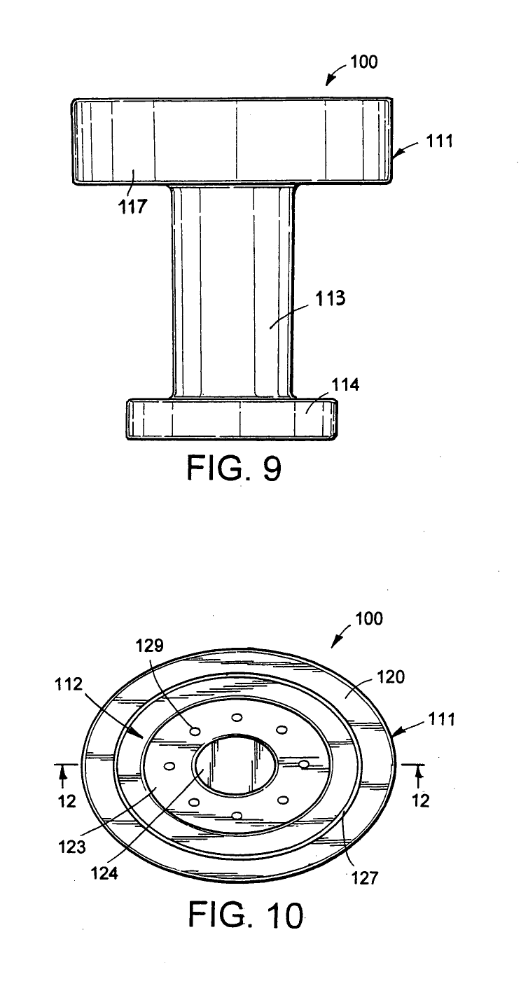

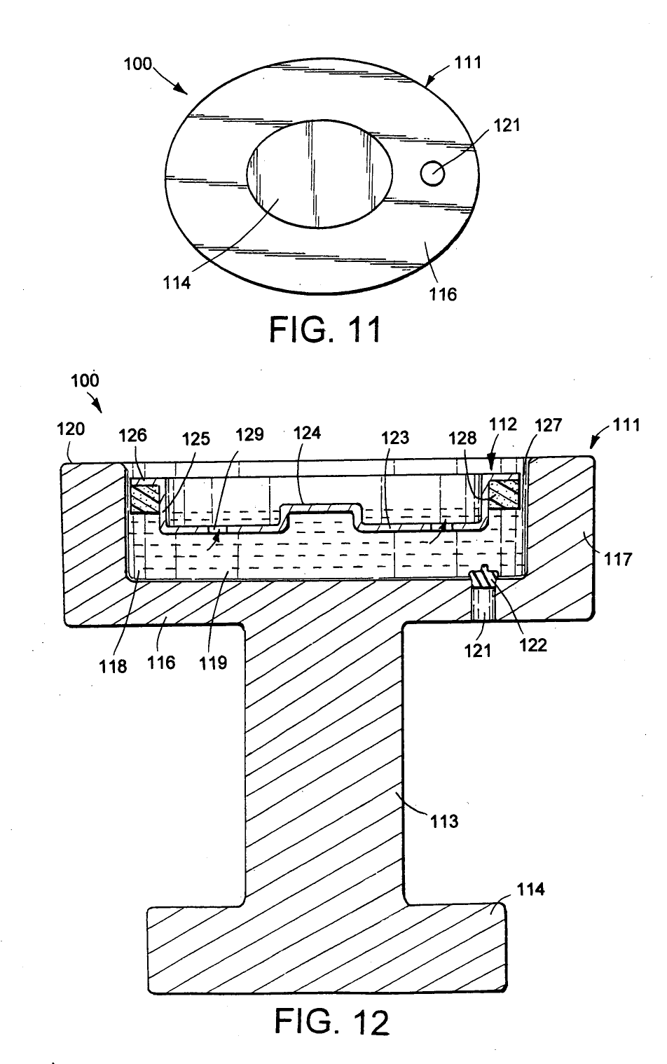

A first alternative embodiment of the bird bath 100 shown in FIGS. 7 to 12 has oval or elliptical shaped bowls 111 and 112. Pedestal 113 and base 114 have oval shapes to provide bird bath 100 with a coordinated oval appearance. The parts of bird bath 100 that correspond with the same parts of bird bath 10 have the same reference numbers with a prefix 1. Inner bowl 112 floats on the water in reservoir 118 in outer bowl 117 as shown in FIG. 12.

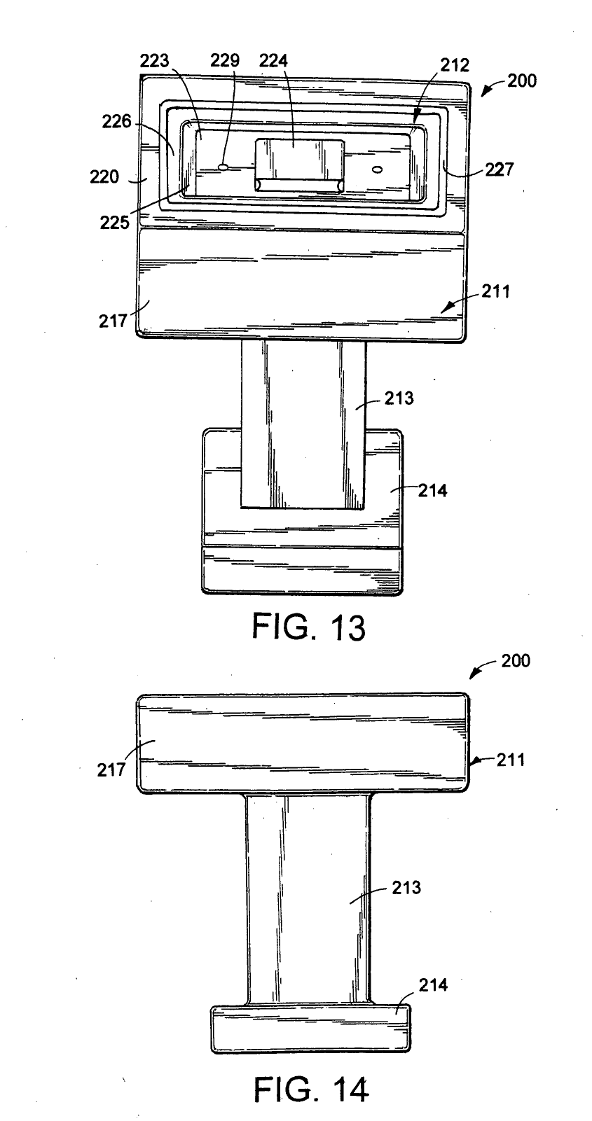

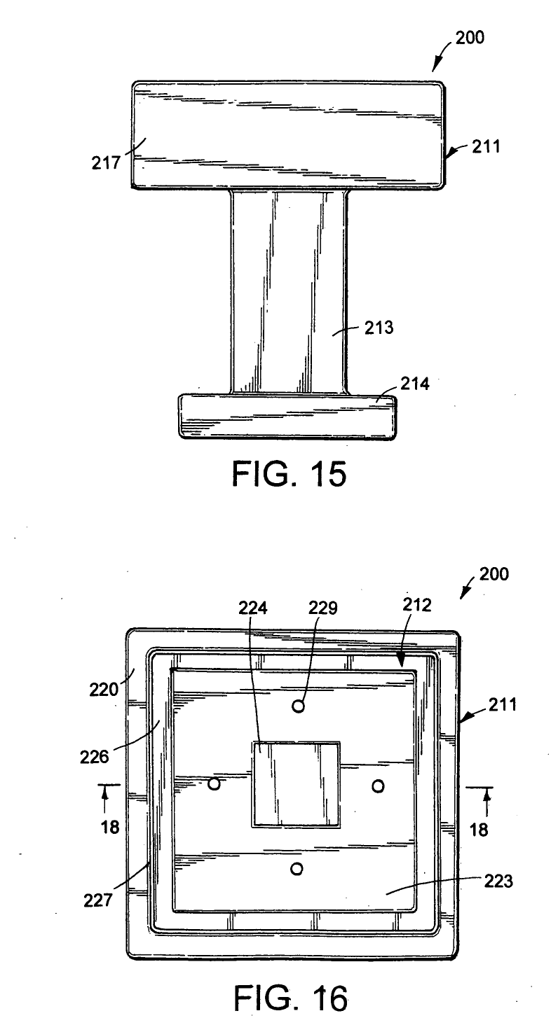

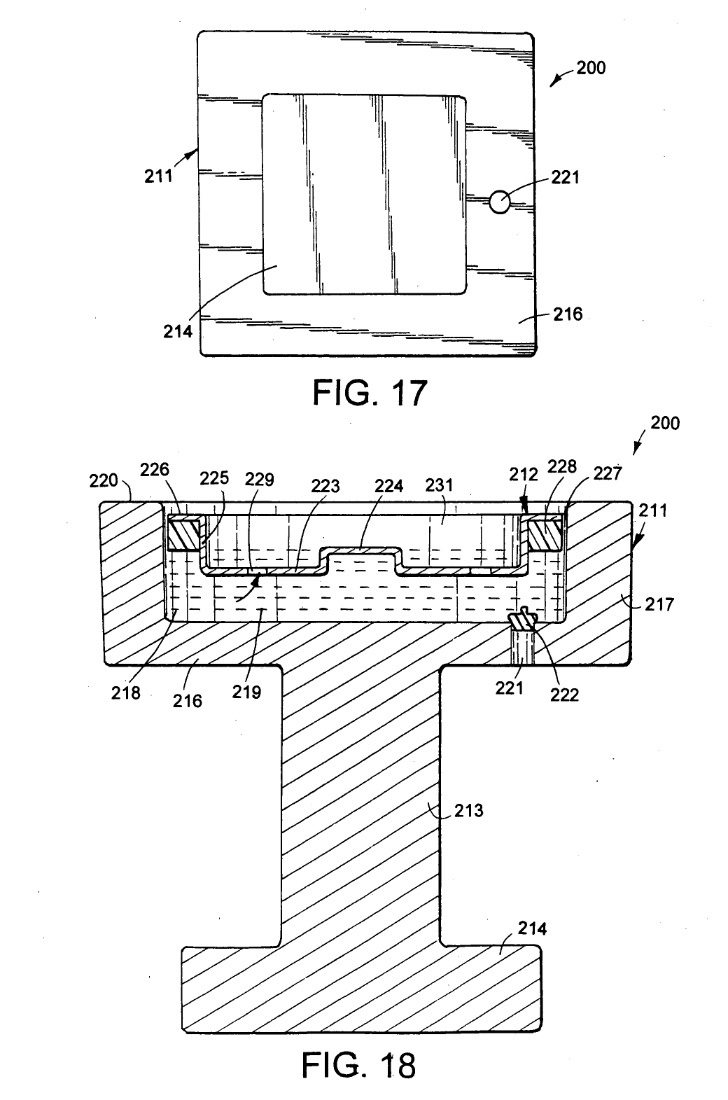

A second embodiment of the bird bath 200 shown in FIGS. 13 to 18 has square shaped bowls 211 and 212. The outer bowl 211 is located on a square pedestal 213 joined to a square base 214 to provide bird bath 200 with a coordinated block or square appearance. The parts of bird bath 200 that correspond with the same parts of bird bath 10 have the same reference numbers with the prefix 2. Square inner bowl 212 floats on the water in reservoir 218 in outer bowl 211 as shown in FIG. 18.

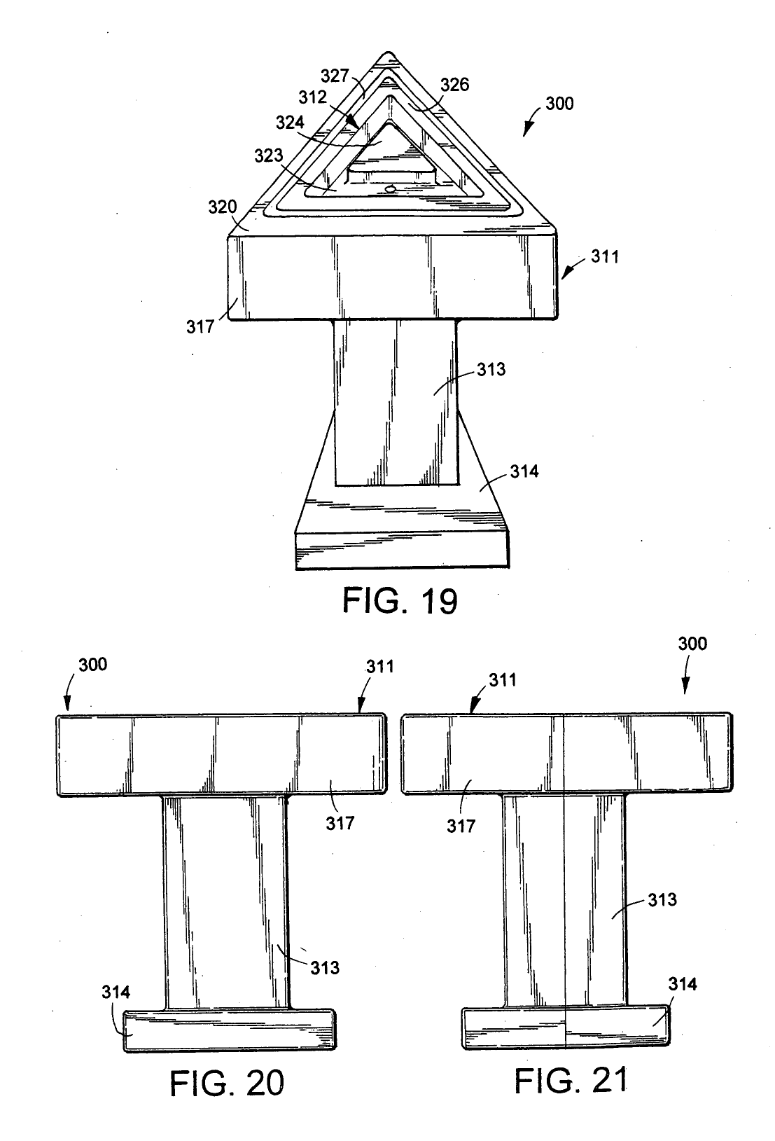

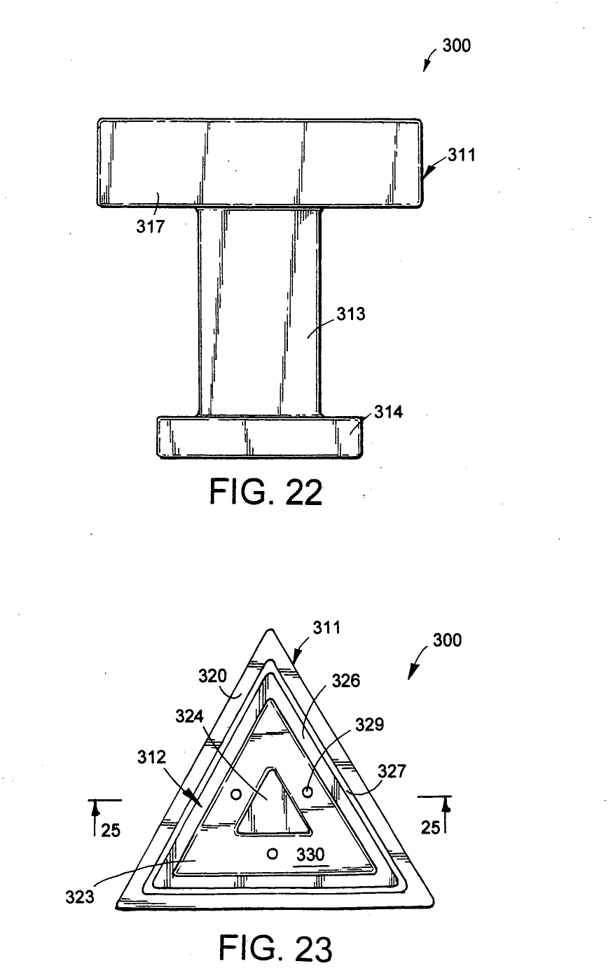

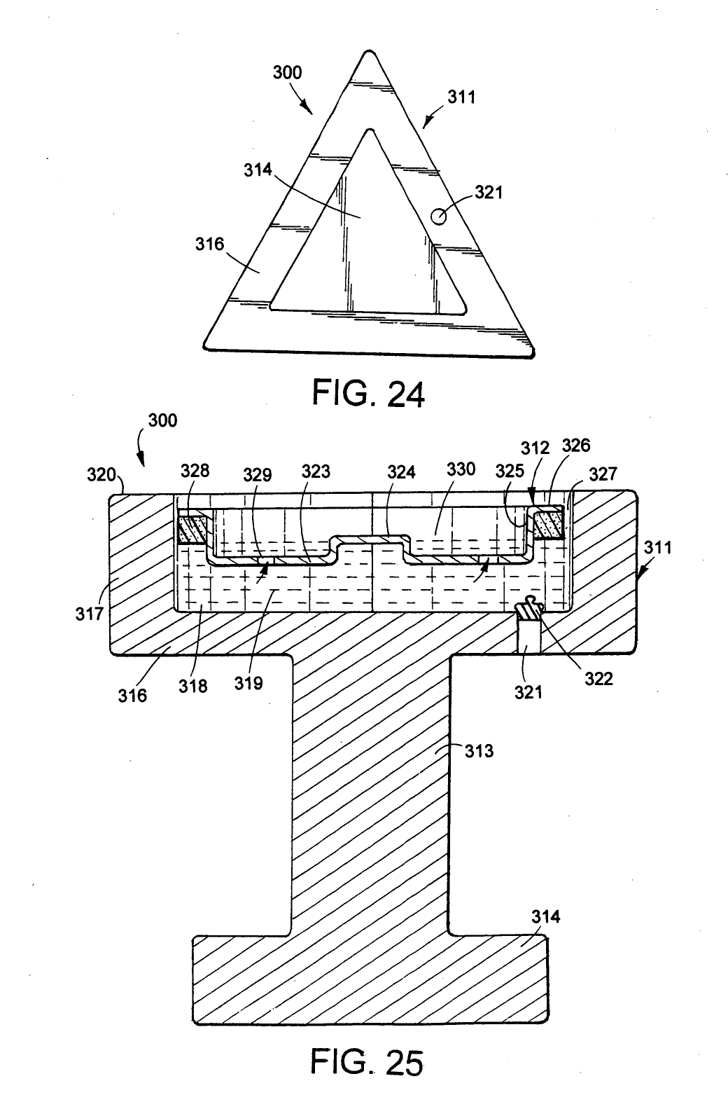

A third embodiment of the bird bath 300 shown in FIGS. 19 to 25 has triangular shaped bowls 311 and 312. The outer bowl 311 is located on a triangular pedestal 313 joined to a triangular base 314. The sides of the triangular bowls 311 and 312 pedestal 313 and base 314 are parallel to provide bird bath 300 with a coordinated triangular appearance. The parts of bird bath 300 that correspond to the same parts of bird bath 10 have the same reference numbers with the prefix 3. Triangular inner bowl 312 floats on the water in reservoir 318 in outer bowl 311 as shown in FIG. 24.

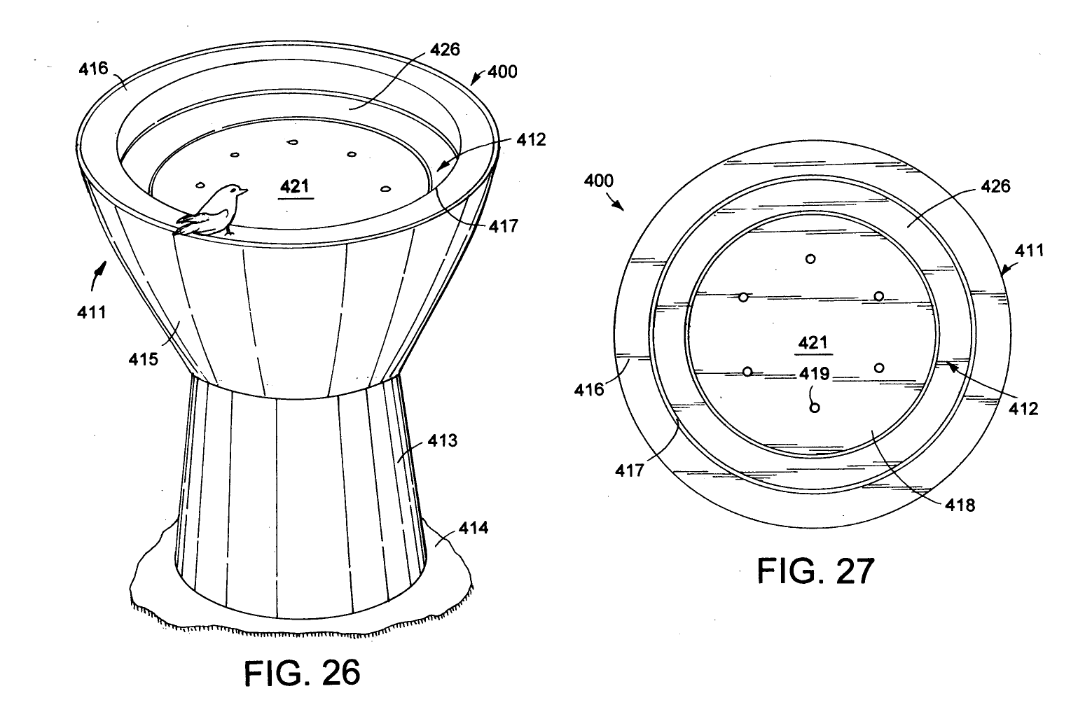

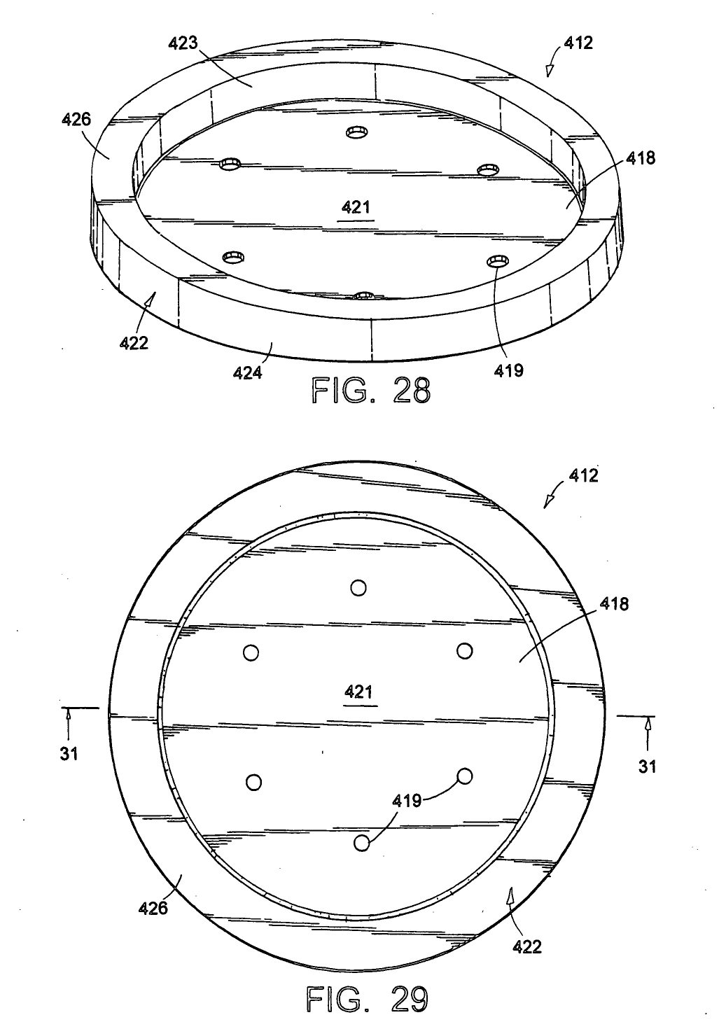

Another embodiment of the bird bath 400, shown in FIGS. 26 and 27, has a first outer bowl 411 and a second inner bowl 412 floating on the water in bowl 411. An upright pedestal or column 413 supports bowl 411 above ground 414. Bowl 411 and pedestal 413 can be a one-piece concrete, plastic or ceramic structure. Alternatively, bowl 411 can rest on top of pedestal 413. Bowl 411 has an upwardly and outwardly directed sidewall 415 and a flat horizontal annular top wall or ledge 416. Sidewall 415 surrounds a reservoir 417 for holding water. Bowl 411 can have a drain hole (not shown) to allow water to drain from basin 417. Birds can perch on ledge 416 and drink water in inner bowl 412. Small birds perch on inner bowl 412 or bathe in the water in inner bowl.

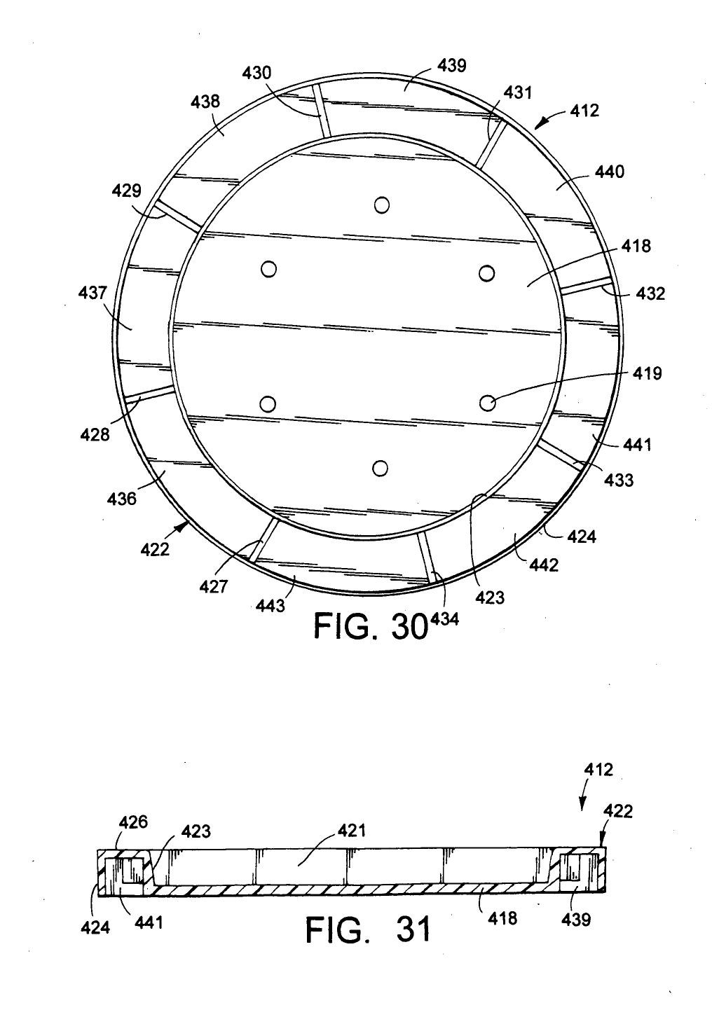

Inner bowl 412, a pan-shaped floating bird bath bowl, comprises a circular flat bottom wall 418 having a plurality of holes 419 to allow water to flow from reservoir 417 into basin 421. A circular rim 422 joined to the outer circular edge of bottom wall 418 is a floatation member that floats inner bowl 412 on the water in reservoir 417. Rim 422 has concentric inner and outer cylindrical sidewalls 423 and 424 and a flat circular top wall 426. The top surface of wall 426 has fine texturing to provide a gripping base for the birds. As shown in FIG. 30, a plurality of radial ribs or gussets 427-434 extend radially between and are secured to sidewalls 423 and 424 and top wall 426. Ribs 427-434 in conjunction with sidewalls 423 and 424 and top wall 426 surround downward open air pockets or chambers 436-443. The air in chambers 436-443 is confined when inner bowl 412 is in the water reservoir 417 whereby the inner bowl 412 floats in the water. The weight of inner bowl 412 lowers bottom wall 418 below the level of the water in reservoir 417. Water flows through holes 419 into basin 421 whereby a shallow amount of water is maintained in basin 421 for birds perched on top wall 426. As water in basin 421 is depleted, inner bowl 412 floating in the water in reservoir 417 lowers with the water level and is supplied with additional water to maintain a shallow amount of water in basin 421.

Inner bowl 412 is a one-piece plastic member. An example of the plastic member is a polypropylene plastic molded with gas to increase its buoyancy. Other types of plastics and materials can be used to make inner bowl 412. The inner bowl 412 is environmentally compatible and easy to remove from the bird bath and cleaned. When inner bowl 412 is placed on the water in reservoir 417, it is self filling with water which flows through holes 419 in bottom wall 418 into basin 421.

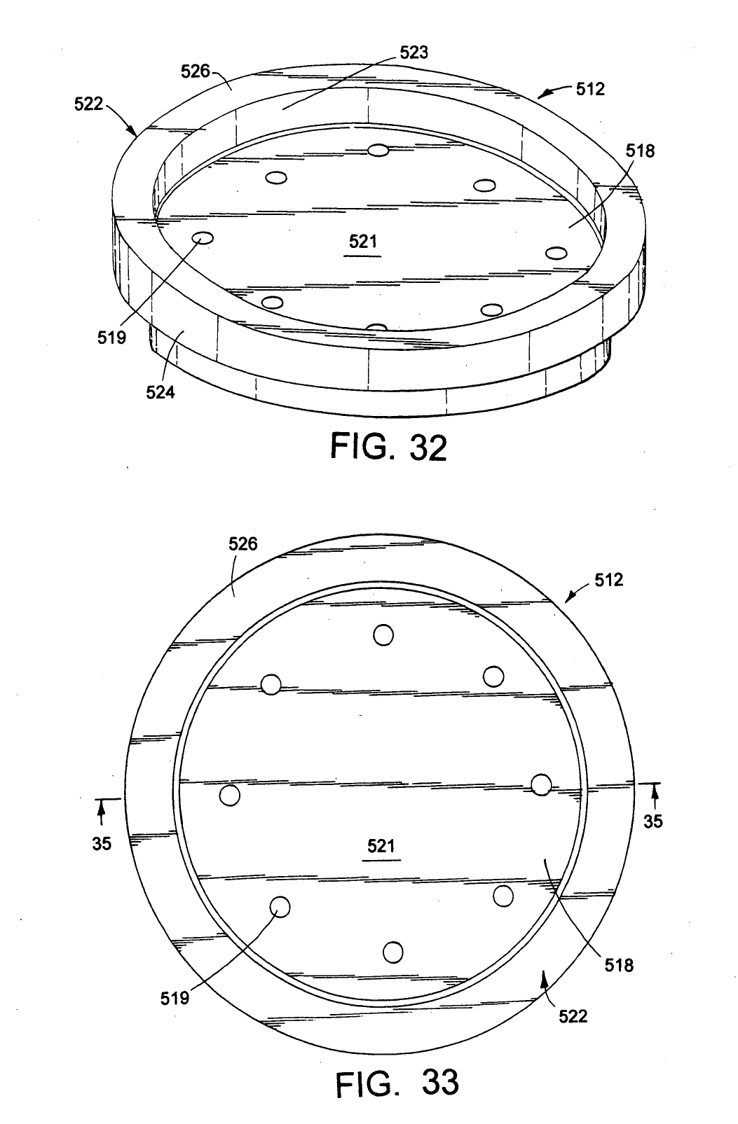

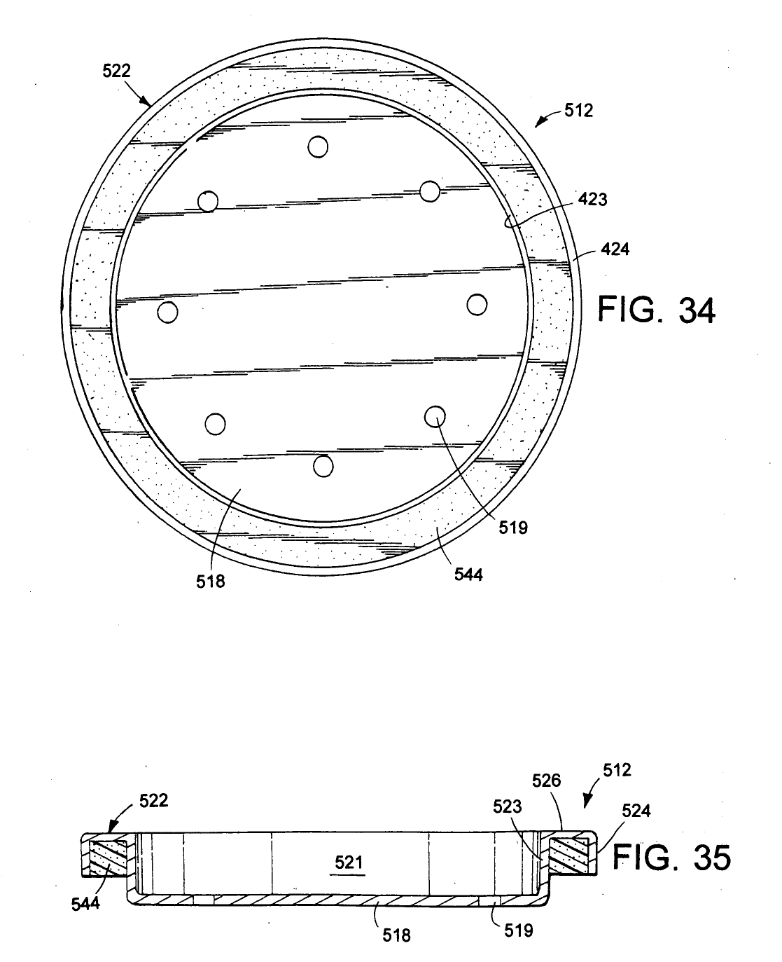

A first modification of the inner bowl, shown in FIGS. 32 to 35, is designated generally at 512. The parts of bowl 512 that correspond to the same parts of inner bowl 412 have the prefix “5” in lieu of “4”. Bowl 512 has a bottom wall 518 containing holes 519. The outer peripheral edge of bottom wall 518 is joined to an annular rim 522. As shown in FIGS. 34 and 35, rim 522 has cylindrical inside and outside sidewalls 523 and 524 and a top wall 526. A continuous ring 544 of foam plastic is located between sidewalls 523 and 524. Ring 544 is a floatation member that retains inner bowl 512 on the surface of a body of water, such as the water in the reservoir of the outer bowl of the bird bath. The floatation member can be a circular tube containing air or other lighter than water devices for floating inner bowl 512 on the water in reservoir of the bird bath.

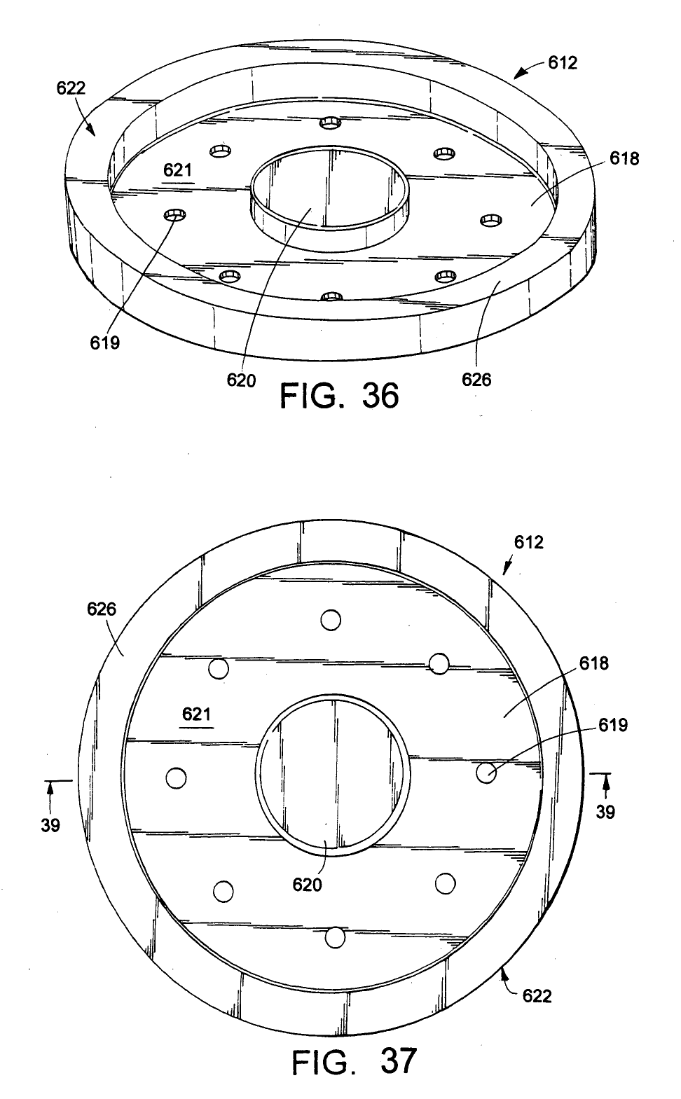

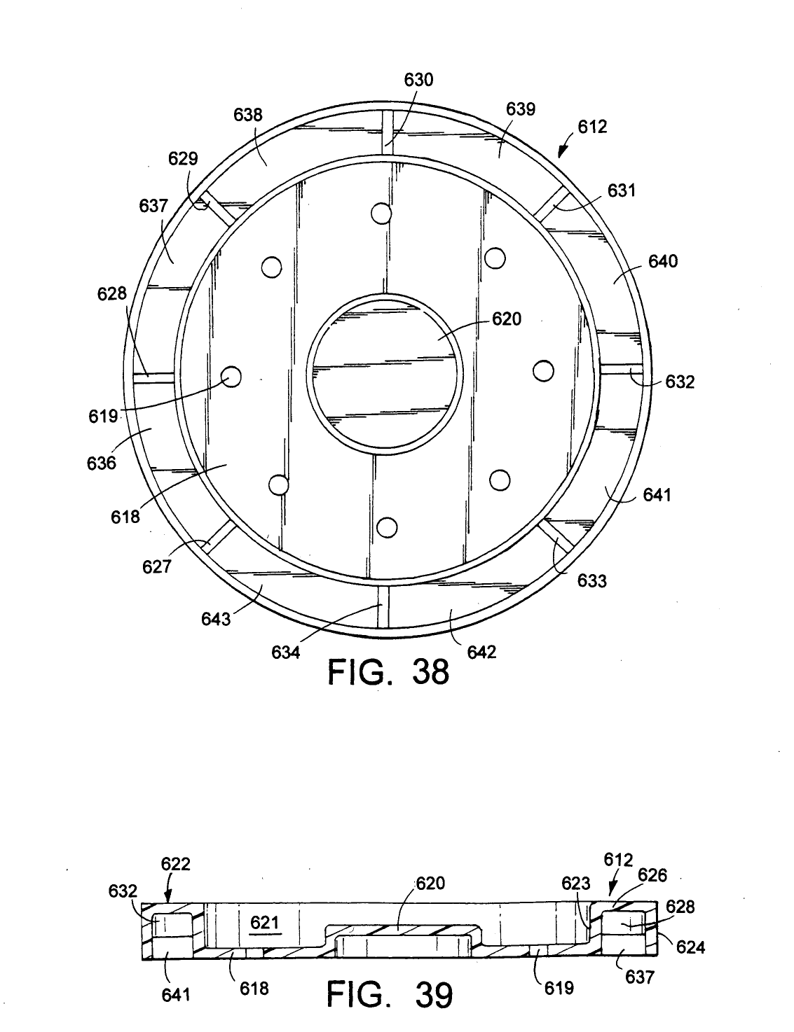

A second modification of the inner bowl, shown in FIGS. 36 to 39, is designated generally at 612. The parts of bowl 612 that correspond to the same parts of inner bowl 412 have the same reference with the prefix “6” in lieu of “4”. Bowl 612 has an annular rim 622 having concentric continuous inner and outer sidewalls 623 and 624 joined to a flat circular top wall 626. A plurality of radial ribs or gussets 627-634 extend radially between and are secured to sidewalls 623 and 624 and top wall 626 to provide air pockets or chambers 636-643. As shown in FIG. 38, air pockets 636-643 are circumferentially arranged around bottom wall 618. In use, the air in pockets 63.6-643 maintains inner bowl 612 on the surface of the water in the reservoir of the bird bath with the bottom wall 618 in the water so as to keep a supply of water in the basin 621 of inner bowl 612. The center portion of bottom wall 618 has an elevated platform or island 620. Platform 620 has a circular shape with a flat top surface used as a perch pad for birds. The surface can have a fine texture to provide a gripping base for birds perching on the platform.

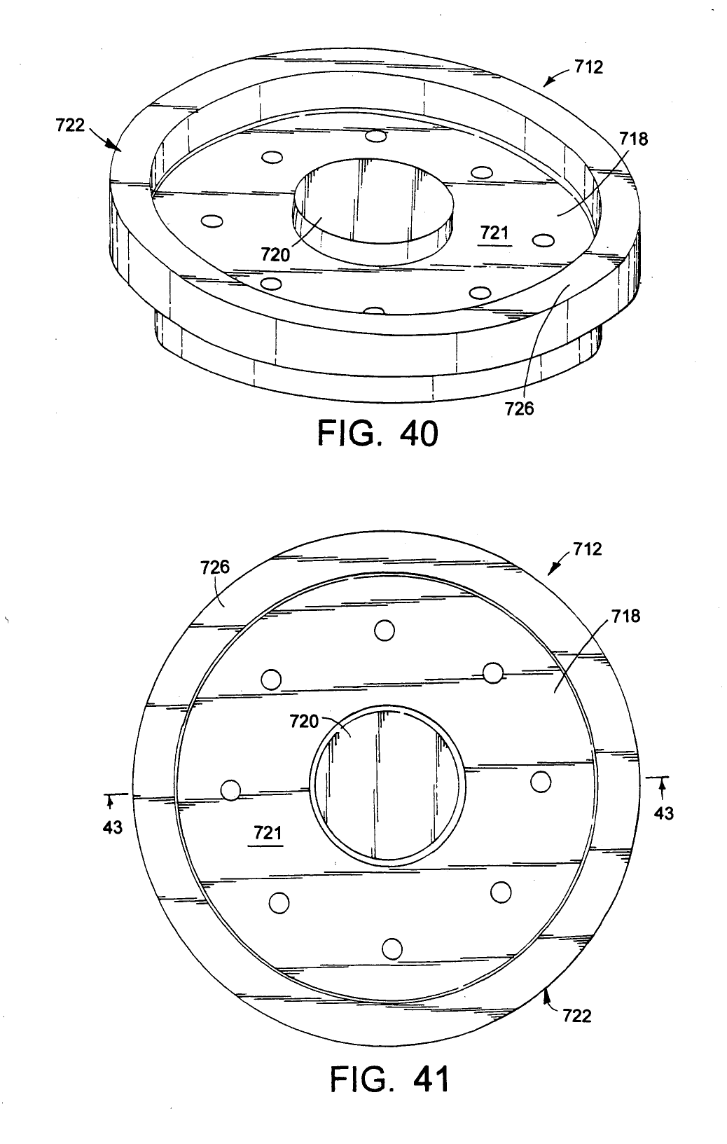

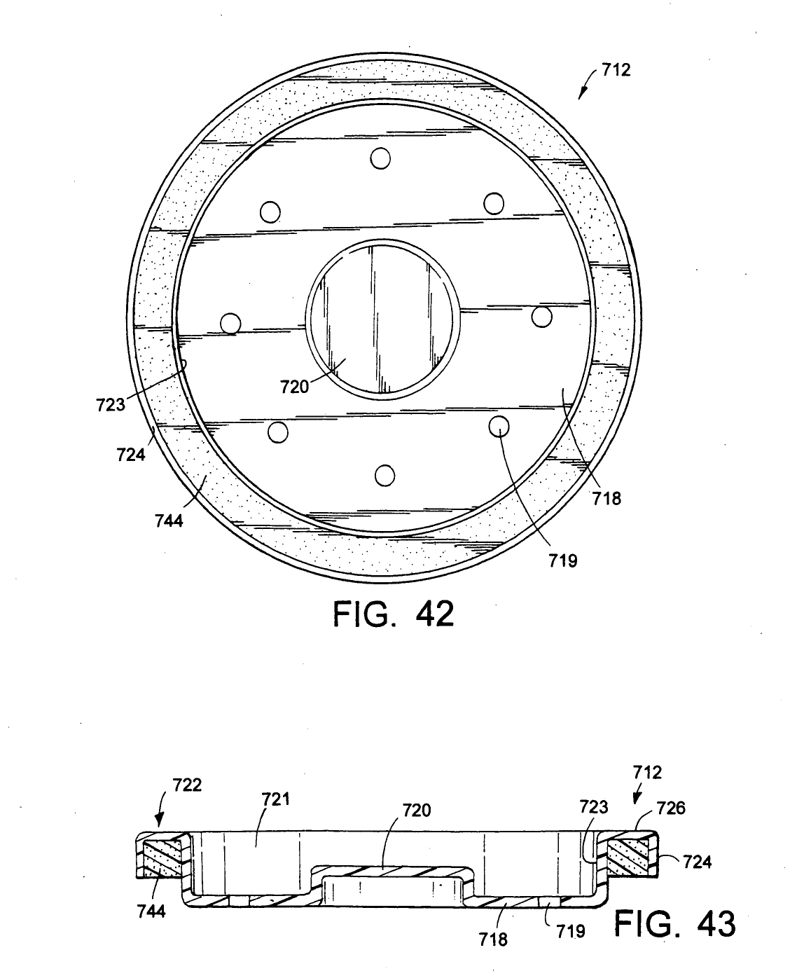

A third modification of the inner bowl, shown in FIGS. 40 to 43, is designated generally as 712. The parts of bowl 712 that correspond to the same parts of bowl 412 have the same reference numbers with the prefix “7” in lieu of “4”. Bowl 712 has an annular rim 722 having cylindrical inside and outside sidewalls 723 and 724 joined to a top wall 726. A continuous ring 744 of foam plastic located between sidewalls 723 and 724 functions as a floatation member that floats bowl 712 in water in a reservoir in a bird bath. The center of bottom wall 718 has an elevated circular platform or island 720 useable as a perch pad for birds. The top surface of platform 720 can have a fine texture to provide a gripping base for birds perching on the platform.

The bird bath has been described with reference to preferred embodiments. It is understood that changes in the shapes, arrangements of parts and materials can be made by persons skilled in the art without departing from the invention.

1. A bird bath comprising: an outer bowl having an open top chamber providing a reservoir for holding water, means for supporting the outer bowl on a surface, an inner bowl located within the chamber having a basin for holding water, a floatation member for supporting the inner bowl on the water in the reservoir, the floatation member comprising a rim surrounding and secured to the bottom wall, said rim having upright inner and outer sidewalls and a top wall joined to the sidewalls, a plurality of circumferentially spaced ribs extended between and joined to said sidewalls, said ribs dividing the space between said sidewalls into a plurality of air pockets whereby the air in said air pockets supports the inner bowl on the water in the reservoir, said inner bowl having a bottom wall submerged in the water in the reservoir, said bottom wall having at least one passage to allow water to flow from the reservoir into the basin of the inner bowl to provide water for birds.

2. The bird bath of claim 1 wherein: the outer bowl has an upright inside sidewall surrounding the open top chamber, said sidewall having a top ledge extended around the chamber.

3-7. (canceled)

8. The bird bath of claim 2 wherein: said inner bowl is spaced inwardly from said inside sidewall of the outer bowl whereby the inner bowl is free to float on the water in the reservoir.

9-10. (canceled)

11. The bird bath of claim 1 wherein: the bottom wall of the inner bowl has an island having a top surface located above the surface of the water in the basin.

12-13. (canceled)

14. A bird bath comprising: an outer bowl having an upright sidewall surrounding a reservoir for holding water, said sidewall having a top opening open to said reservoir, an inner bowl comprising a pan-shaped member having a bottom wall and an upright rim joined to the bottom wall providing a basin for holding water, said bottom wall having a plurality of holes allowing water to flow from the reservoir into the basin when the inner bowl is floated on the water in the reservoir, said rim having upright inner and outer sidewalls and a top wall joined to the inner and outer sidewalls and a plurality of circumferentially spaced radial ribs extended between and secured to said inner and outer sidewalls, said ribs dividing the space between said inner and outer sidewalls into a plurality of air pockets whereby the air in said pockets supports the inner bowl on the water in the reservoir.

15. The bird bath of claim 14 wherein: the outer bowl includes a top ledge surrounding the open top chamber providing a perch for birds.

16. The bird bath of claim 14 wherein: said bottom wall of the inner bowl has an island having a top surface located above the surface of the water in the basin of the inner bowl.

17. A bird bath bowl adapted to float on a body of water comprising: a pan-shaped member having a bottom wall and an upright rim joined to the bottom wall providing a basin for holding water, said bottom wall having at least one hole to allow water to flow into the basin, said rim having upright inner and outer sidewalls and a top wall joined to said inner and outer sidewalls, and a plurality of circumferentially spaced radial ribs extended between and secured to said inner and outer sidewalls, said ribs dividing the space between the inner and outer sidewalls into a plurality of air pockets to confine air in each of said pockets supporting the bird bath bowl on a body of water.

18. The bird bath bowl of claim 17 wherein: the bottom wall has a plurality of holes to allow water to flow into the basin.

19. The bird bath bowl of claim 17 wherein: said bottom wall includes an upwardly directed island having a top surface providing a perch for birds.

20. The bird bath bowl of claim 19 wherein: said island has a textured top surface providing a gripping based perch for birds.

21. A bird bath bowl adapted to float on a body of water comprising: a pan-shaped member having a flat bottom wall having outer peripheral edge and at least one hole to allow water to flow through the bottom wall, an upright inner sidewall having a top edge and a bottom edge, said bottom edge joined to the peripheral edge of the bottom wall providing a basin for holding water when the member is located on a body of water, a top wall joined to the top edge of the sidewall, said top wall being located in a plane above the plane of the bottom wall, and means associated with the sidewall and top wall for supporting the bird bath bowl on a body of water with the bottom wall below the surface of the body of water to allow water to flow through said hole into the basin.

22. The bird bath bowl of claim 21 wherein: the means associated with the inner sidewall and top wall for supporting the bird bath bowl on a body of water comprises a downwardly extended outside sidewall joined to the top wall located generally concentric with the inner sidewall providing at least one air pocket between the inner and outer sidewalls and below the top wall whereby air in said pocket supports the bird bath bowl on a body of water.

23. The bird bath bowl of claim 22 including: at least one rib extended between and joined to said inner and outer sidewalls and top wall.

24. The bird bath bowl of claim 22 wherein: said bottom wall includes an upwardly directed island having a top surface providing a perch for birds.

25. The bird bath bowl of claim 21 wherein: the means associated with the inner sidewall and top wall for supporting the bird bath bowl on a body of water comprises a floatation ring surrounding and engaging the inner sidewall below the top wall.

26. The bird bath bowl of claim 25 wherein: the ring is an annular ring of foam plastic.

27. The bird bath bowl of claim 25 including: a downwardly extended outside sidewall joined to the top wall located generally concentric with the inner sidewall providing a space between said inner and outer sidewalls and below the top wall, said floatation ring being located in said space.

28. The bird bath bowl of claim 25 wherein: said bottom wall includes an upwardly directed island having a top surface providing a perch for birds.
